(19) United States
(12) Patent Application Publication
(10) Pub. No.: US 2012/0092233 A1
(43) Pub. Date: Apr. 19, 2012

(54) DISPLAY CONTROL APPARATUS AND DISPLAY CONTROL METHOD

(75) Inventor: Takashi Kazamaki, Osaka-shi (JP)

(73) Assignee: SHARP KABUSHIKI KAISHA, Osaka-shi, Osaka (JP)

(21) Appl. No.: 13/129,763

(22) PCT Filed: Nov. 16, 2009
(86) PCT No.: PCT/JP2009/069440

§ 371 Date: Dec. 22, 2011

(30) Foreign Application Priority Data
Nov. 18, 2008 (JP) 2008-294602

(51) Int. Cl. G09G 5/00

(52) U.S. Cl. 345/1.1

(57) ABSTRACT

There is provided a display control apparatus, usability of which is improved such that, when contents are divisionally displayed on a plurality of screens, it is determined whether or not the plurality of contents displayed on the plurality of screens are related to each other to perform display control.

The display control apparatus includes: a display unit that can display contents on one screen or a plurality of screens; a designating unit that designates an arbitrary position on the screen of the display unit; a determining unit that, when the contents are displayed on the plurality of screens of the display unit, determines whether or not the contents are related to each other; and a control unit that switches the screen including the position designated by the designating unit based on a determination result obtained by the determining unit.

### TECHNICAL FIELD

The present invention relates to a display control apparatus and a display control method and, more particularly, to a display control apparatus and a display control method that, when a plurality of contents are divided and displayed on a plurality of screens of a display unit of an electronic appliance, determines whether or not the contents are related to each other to control the display of the contents.

### BACKGROUND ART

A display device used as an output device of an electronic appliance displays a content on one screen, or divisionally displays a plurality of contents on a plurality of screens, by switching display states depending on types and amounts of information of contents to be displayed. For example, when a plurality of contents are divisionally displayed on a plurality of screens, a user selects a display screen and further inputs information to the selected screen, deletes or highlights the information on the selected screen, extends, reduces, or moves the screen.

FIGS. 10(a) and 10(b) show display screens of an electronic appliance which is applied to an electronic dictionary. FIG. 10(a) shows a display state in which two contents not related to each other are divisionally displayed on two upper and lower screens of a display unit 50 of the electronic dictionary. On the upper screen, “ [symbol] ” and a meaning thereof are displayed. On the lower screen, “ [symbol] ” and a meaning thereof are displayed. In this display state, when a touching operation is performed on the upper screen by using a touch pen 60 or a mouse (cursor (not shown)), the electronic dictionary recognizes that the operated upper screen is a selected screen. An action to the upper screen is then performed. FIG. 10(a) shows a case in which a “syllable” is highlighted with the touch pen 60 or the mouse. As shown in FIG. 10(b), a letter selecting action is performed. FIG. 10(b) shows the highlighted portion with a square frame.

FIG. 11(a) shows a display state in which one content is displayed on one display screen of the display unit 50. In this display state, when a screen operation is performed with the touch pen or the mouse, an action to the screen is performed. FIG. 11(b) shows a case in which a “syllable” is selected with the touch pen or the mouse. As shown in FIG. 11(b), a letter selecting action is performed.

In this manner, in both of a case in which a content is displayed on one screen of the display unit 50 and a case in which a plurality of contents are displayed on a plurality of screens, the display device performs the same action in response to an operation performed with the touch pen or the mouse.

For example, since a compact mobile electronic appliance such as an electronic dictionary accepts limited operations, an action state conveniently changes depending on a display state of a display screen to improve operability. The display state indicates a case in which a content is displayed on one screen, a case in which a plurality of contents are divisionally displayed on a plurality of screens, a case in which a plurality of contents displayed on a plurality of screens are related to each other, or a case in which a plurality of contents are not related to each other. The action state indicates highlighting and screen transition.

From this point of view, Patent Document 1 (Japanese Unexamined Patent Publication No. 10-326280) discloses a display method of an electronic dictionary. More specifically, when one is selected from a plurality of display modes, thereafter, various icons and a screen design displayed on a screen are displayed in the selected display mode. For example, in item name searching, each time a letter is input to an item name input area, item names serving as candidates displayed in a candidate item name display area are narrowed down. When a mouse cursor is pointed to a main direction word listed as a candidate, a read title is displayed like a balloon help. Items of the electronic dictionary are collected and stored in accordance with an arbitrary theme item, or, in contrast thereto, the theme item is read to make it possible to immediately access items included in the theme item.

Patent Document 2 (Japanese Unexamined Patent Publication No. 2008-117181) discloses a mobile phone terminal resources of which are limited to more appropriately execute a plurality of applications, and this mobile phone terminal includes, as action modes, a full-screen mode in which a display screen is allocated to one application, a focus switching mode in which focuses are switched among a plurality of divided areas allocated respectively with applications, and a small screen mode that updates a display content in a divided area in accordance with execution of an application in a focused divided area, and switches the action modes depending on an operation to an operation unit. An application is executed in only a focused divided area of the plurality of divided areas, and the content of the application is displayed in the divided area.

### PRIOR ART DOCUMENTS

### Patent Documents

Patent Document 1: Japanese Unexamined Patent Publication No. 10-326280
Patent Document 2: Japanese Unexamined Patent Publication No. 2008-117181

### SUMMARY OF THE INVENTION

### Problem to be Solved by the Invention

According to Patent Documents 1 and 2, different actions are performed depending on selected display modes, so that the operability of an electronic dictionary is improved. However, in an electronic appliance such as an electronic dictionary having limited functions, action states set by a user are often limited by a display state of a display screen. In such a case, when the action state set by the user is controlled by the display state, the operability can be more improved.

The present invention has been made in consideration of the above problem, and an object thereof is to provide a display control apparatus and a display control method that, when contents are divisionally displayed on a plurality of screens of a display unit, determines whether or not the contents displayed on the plurality of screens are related to each other and performs display control to improve operability.

### Means for Solving the Problem

In order to solve the problem, a display control apparatus according to the present invention includes: a display unit that can display contents on one screen or a plurality of screens; a designating unit that designates an arbitrary position on the screen of the display unit; a determining unit that determines whether or not the contents displayed on the plurality of screens are related to each other; and a control unit that switches the screen including the position designated by the designating unit on the basis of a determination result obtained by the determining unit.

In the display control apparatus according to the present invention, the display unit has a display state in which one content is displayed on one screen and a display state in which a plurality of contents are divisionally displayed on a plurality of screens. Furthermore, when a plurality of contents are divisionally displayed on a plurality of screens, the plurality of contents may be related to each other or may not be related to each other. In this case, for example, when the present invention is applied to a display control apparatus of an electronic dictionary, pieces of information related to each other include a direction word, a translated word thereof (word meaning), description information, an example sentence, and the like. The display state of unrelated pieces of information is such that direction words different from each other are displayed. In the display state of related pieces of information, the contents may be displayed on one of the screens in a list, and detailed information on one of the contents in the list may be displayed on another one of the screens.

In the display control apparatus according to the present invention, when the determining unit determines that the contents displayed on the plurality of screens are related to each other, detailed information including one or a plurality of direction words are displayed on one of the screens, and relevant information corresponding to one of the direction words is displayed on another one of the screens.

When the determining unit determines that the contents displayed on the plurality of screens are not related to each other, a direction word is displayed on one of the screens, and another direction word different from the direction word is displayed on another one of the screens.

In this manner, when the plurality of contents are divisionally displayed on the plurality of screens and are pieces of information related to each other, it can be said that a user reaches a target screen and that the user watches a description screen thereof in detail. For this reason, in this state, it is matched with a user's operation purpose that a user's screen touch operation is not a screen transition operation but a selecting operation out of the display contents. In this manner, usability of the electronic dictionary is improved.

When a plurality of contents are divisionally displayed on a plurality of screens and are not related to each other, a user visually compares the plurality of screens with each other to determine which one of the screens displays a desired content. For this reason, in this state, a user's screen touch operation is not a selecting operation out of the display contents but a screen transition operation. Therefore, the display control apparatus according to the present invention switches to display in a full-screen size the touched screen out of the divisionally displayed screens. In this manner, the operability can be improved.

According to the present invention, in order to solve the above problem, from another point of view, a display control method causes a computer to execute: a display step of displaying contents on a plurality of screens; a designating step of designating an arbitrary position on the plurality of screens; a determining step of determining whether or not the contents displayed on the plurality of screens are related to each other; and a control step of switching a screen including the position designated in the designating step on the basis of a determination result obtained in the determining step. The usability of the electronic appliance is therefore improved.

### Effect of the Invention

According to the display control apparatus of the present invention, there is provided a display control apparatus that, when contents are divisionally displayed on a plurality of screens, determines whether or not the plurality of contents displayed on the plurality of screens are related to each other so as to perform display control and improve the operability.

### BRIEF DESCRIPTION OF THE DRAWINGS

FIG. 1 is a block diagram of a display control apparatus according to the present invention.

FIGS. 2(a) and 2(b) are block diagrams each showing a data portion of the display control apparatus according to the present invention.

FIGS. 3(a) to 3(c) are explanatory diagrams each showing a display state of an electronic dictionary to which the display control apparatus according to the present invention is applied.

FIGS. 4(a) to 4(c) are explanatory diagrams each showing another display state of the electronic dictionary to which the display control apparatus according to the present invention is applied.

FIGS. 5(a) to 5(c) are explanatory diagrams each showing still another display state of the electronic dictionary to which the display control apparatus according to the present invention is applied.

FIGS. 6(a) and 6(b) are explanatory diagrams each showing still another display state of the electronic dictionary to which the display control apparatus according to the present invention is applied.

FIG. 7 is a first flow chart of the display control apparatus according to the present invention.

FIG. 8 is a second flow chart of the display control apparatus according to the present invention.

FIG. 9 is a third flow chart of the display control apparatus according to the present invention.

FIGS. 10(a) and 10(b) are explanatory diagrams each showing a display state of a conventional display control apparatus.

FIGS. 11(a) and 11(b) are explanatory diagrams each showing another display state of the conventional display control apparatus.

### MODE FOR CARRYING OUT THE INVENTION

The present invention is to, when a plurality of contents are divisionally displayed on a plurality of screens of a display unit of an electronic appliance, determines whether or not the contents are related to each other to perform display control.

In general, a display device used as an output device of an electronic appliance includes a display state in which one content is displayed on one screen and a display state in which a plurality of contents are divisionally displayed on a plurality of screens. Furthermore, the contents divisionally displayed on the plurality of screens may be related to each other or may not be related to each other.

When the display control apparatus according to the present invention is executed as a display control apparatus for an electronic dictionary, a description content of a target word is displayed in a display state in which one content is displayed on one screen, and this state can be said that a user reaches a target screen. In the state in which one content is displayed on one screen, a user's screen touch operation does not require screen transition. Therefore, the user's screen touch in this state is a selecting operation to the display content in correspondence with a user's operation purpose. In this manner, the operability of the electronic dictionary is improved.

In a display state in which an electronic dictionary divisionally displays a plurality of contents on a plurality of screens, when the plurality of contents are pieces of information that are not related to each other, a user visually compares the plurality of screens with each other to determine which one of the screens displays a desired content. For this reason, a user's screen touch is not a selecting operation to the display content but a screen transition operation. Therefore, the display control apparatus according to the present invention switches to display the touched screen out of the divisionally displayed screens in a full-screen size. Accordingly, the operability can be improved.

It can be said that the display state in which the electronic dictionary divisionally displays a plurality of contents on a plurality of screens is, when the plurality of display contents are pieces of information related to each to each other, a state in which a user reaches a target screen as well as a state in which the user watches the description screen in detail. For this reason, in such a state, when the user touches the screen, a user's operation purpose is not matched with a screen transition operation but a selecting operation to the display contents. In this manner, the operability of the electronic dictionary is improved.

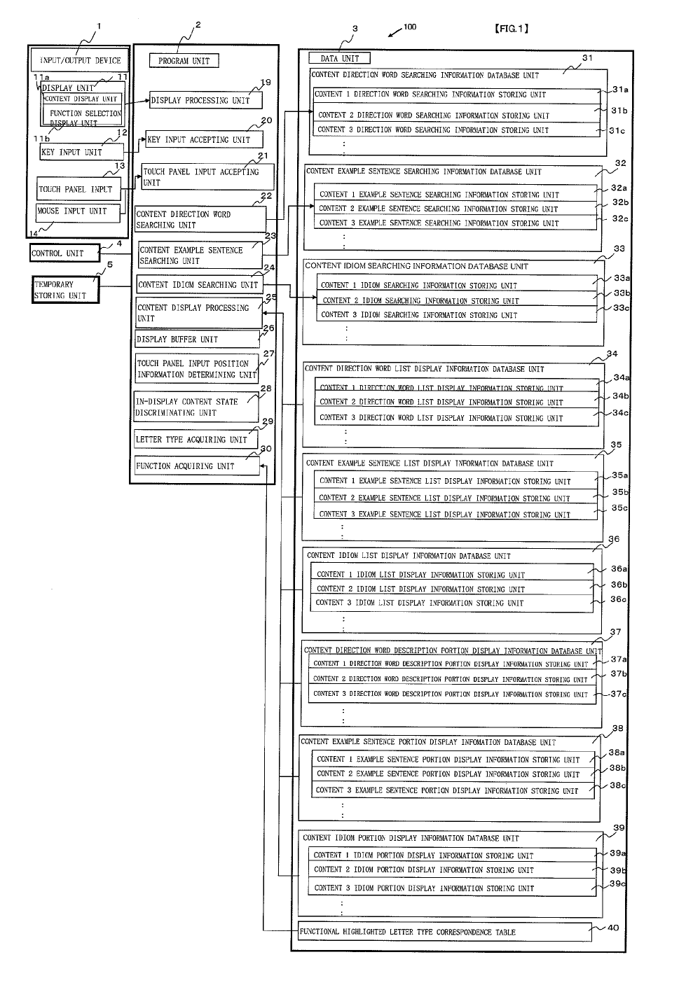

The present invention provides the display control apparatus the operability of which is improved. For this reason, the display control apparatus is configured as shown in a block diagram in FIG. 1.

FIG. 1 is a block diagram of an electronic appliance 100 according to the present invention.

The electronic appliance 100 according to the present invention is, for example, embodied as a compact mobile electronic appliance such as an electronic dictionary, the electronic appliance is divided into an upper body and a lower body, and the upper body and the lower body are foldably jointed to each other with a hinge mechanism. The upper body includes a display unit, and the lower body includes a control unit of the electronic appliance. The display unit included in the upper body has a large screen that mostly occupies an area of the upper body and displays various pieces of information. For example, when the electronic appliance is an electronic dictionary, an input direction word, a designation, or an instruction is displayed. A translated word (word meaning) corresponding to a direction word, an explanatory sentence, relevant information, phonetic symbols, or an example sentence is displayed. The control device 100 of the electronic appliance according to the present invention controls display of the display unit included in the upper body. It is not necessary for the present invention that the electronic appliance is divided into the upper body and the lower body so as to be foldably jointed to each other with the hinge mechanism in this manner. Alternatively, the electronic appliance may have an integral configuration.

On a surface of the lower body, a keyboard is arranged and a touch panel having a small screen is arranged. The small screen touch panel is used as a handwriting letter input unit, a designating unit with a pen or a finger, or an instruction unit. In the present invention, the small screen touch panel may not be arranged on the surface of the lower body.

In the following explanation, an electronic dictionary is explained as an example. However, the control device for the electronic appliance according to present invention can be applied to a PDA, a mobile phone, a notebook personal computer, or the like.

The electronic appliance 100 according to the present invention includes an input/output device unit 1, a program unit 2, a data unit 3, a control unit 4, and a temporary storing unit 5.

The input/output device unit 1 includes a display unit 11, a key input unit 12, a touch panel input unit 13, and a mouse input unit 14.

Although the display unit 11 is typically a liquid crystal display device, an organic EL display device, a plasma display device, or a display device such as electronic paper can be alternatively used. For example, when an electronic appliance is obtained by foldably jointing an upper body and a lower body to each other, the display unit 11 is arranged on the upper body and has a display screen having an area substantially equal to that of the upper body. The display unit 11 has a content display unit 11a and a function selection display unit 11b. The content display unit 11a and the function selection display unit 11b may be displayed as windows in a display screen of the display unit 11.

The content display unit 11a displays a direction word input with the key input unit 12 and also displays a translated word (word meaning), an explanatory sentence, relevant information, phonetic symbols, an example sentence, and the like as search results of the direction word. The content display unit 11a displays, in addition to a letter string, a symbol, a graphic, a table, a photograph, a moving image, and the like. In the present invention, it is assumed that the letter string is mainly displayed.

The function selection display unit 11b is a part that displays an executable action function item after a user selects a letter range. The action function item is preferably automatically displayed. As the function item displayed on the function selection display unit 11b, only an executable function item is preferably displayed depending on letter type function corresponding information.

The key input unit 12 is configured by a QWERTY keyboard and arranged on a surface of the lower body. Direction words such as letters and numbers are input by using the keyboard. Commands of designation and instruction are input to the electronic dictionary by using the keyboard. It may be used as the keyboard not only the QWERTY keyboard described above but also “Katakana-syllabary keyboard” on which hiragana characters are arranged in the order of the Japanese syllabary or a dedicated keyboard coping with a different language.

The touch panel input unit 13 is a part in which inputting is performed with a pen or a finger to a touch panel arranged to overlap the front surface of the display unit 11, and is used as a handwriting input unit, a position designating unit, a screen selecting unit, and a highlighting unit. The touch panel is of an analog resistive type, an ultrasonic surface acoustic wave type, an infrared shielding type, an electrostatic type, an electromagnetic induction type, or an image recognition type. Although the touch panels of all the types can be used, the analog resistive type is used herein. A touch panel input unit may be arranged also on a display unit arranged near the keyboard unit on the lower body, so as to be used as a handwriting input unit, a position designating, a screen selecting, and a highlighting. In the present invention, the touch panel input unit may not be arranged on the surface of the lower body.

In place of the touch panel input unit 13, or together with the touch panel input unit 13, the mouse input unit 14 may be arranged. By using the mouse input unit 14, an arbitrary position can be designated, a screen can be selected, and an area such as a letter range can be designated.

The program unit 2 includes a display processing unit 19, a key input accepting unit 20, a touch panel input accepting unit 21, a content direction word searching unit 22, a content example sentence searching unit 23, a content idiom searching unit 24, a content display processing unit 25, a display buffer unit 26, a touch panel input position information determining unit 27, an in-display content state discriminating unit 28, a letter type acquiring unit 29, and a function acquiring unit 30. In addition to the above, although not shown, a control program, a document creating program, and a graphic/table creating program for an electronic dictionary are included.

The display processing unit 19 is a part that processes display data of the display unit 11.

The key input accepting unit 20 is a part that accepts an input from the key input unit 12 to process information on a key operation.

The touch panel input accepting unit 21 is a part that accepts an input from the touch panel input unit 13 operated with a pen or a finger and detects input coordinates or an input coordinate area. The touch panel input accepting unit 21 also accepts an input from the touch panel input unit of the display unit 11 arranged near the keyboard to detect input coordinates or an input coordinate area. When the mouse input unit 14 is arranged, an input operation of the mouse input unit 14 is accepted, and information processing is performed by a designating operation that designates mouse operation information such as an arbitrary position, a screen selecting operation that selects a screen, and an area operation that designates an area.

The key input unit 12 that inputs the keyword, the touch panel input unit 13 that highlights the keyword, or the mouse 14 that highlights the keyword configures a letter selecting unit.

The content direction word searching unit 22 is a part that searches for a direction word of a content direction word searching information database unit 31 stored in the data unit 3 by using a keyword input with the key input unit 12, a keyword highlighted with the touch panel input unit 13, or a keyword highlighted with the mouse 14. The content direction word searching unit 22 is used in a case in which an input keyword is composed of one English word, and searches in the content direction word searching information database unit 31 by using such one English word as the keyword.

The content example sentence searching unit 23 is a part that searches in a content example sentence searching information database unit 32 stored in the data unit 3 when a keyword input with the key input unit 12, a keyword highlighted with the touch panel input unit 13, or a keyword highlighted with the mouse input unit 14 is composed of a plurality of English words.

The content idiom searching unit 24 is a part that searches in a content idiom searching information database unit 33 stored in the data unit 3 when a keyword input with the key input unit 12, a keyword highlighted with the touch panel input unit 13, or a keyword highlighted with the mouse input unit 14 is composed of a plurality of English words.

The content display processing unit 25 is connected to a content direction word list display information database unit 34, a content example sentence list display information database unit 35, a content idiom list display information database unit 36, a content direction word description portion display information database unit 37, a content example sentence portion display information database unit 38, and a content idiom portion display information database unit 39 so as to process content display information.

The display buffer unit 26 is a part that temporarily stores display data to be processed by the display processing unit 19.

The touch panel input position information determining unit 27 is a part that determines an input position on the basis of input coordinate information accepted by the touch panel input accepting unit 21. The touch panel input position information determining unit 27 determines whether or not a letter is present at an input position.

The in-display content state discriminating unit 28 is a part that discriminates a display state of an in-display content on the basis of the display data temporarily stored in the display buffer unit 26. For example, it is discriminated whether one or a plurality of screens are being displayed. Further, it is discriminated whether or not a position designated with a touch pen or a mouse is a content display portion.

The letter type acquiring unit 29 is a part that discriminates and acquires a letter type of a letter string input with the key input unit 12, a letter string highlighted with the touch panel input unit 13, or a letter string highlighted with the mouse input unit 14. For example, an English word, a plurality of English words, a Japanese word, a text including two or more languages such as Japanese and English, and a text including a symbol except for a language are discriminated from each other to acquire a letter type. In this case, letters configured by two or more languages are used in dictionaries loaded on the electronic dictionary.

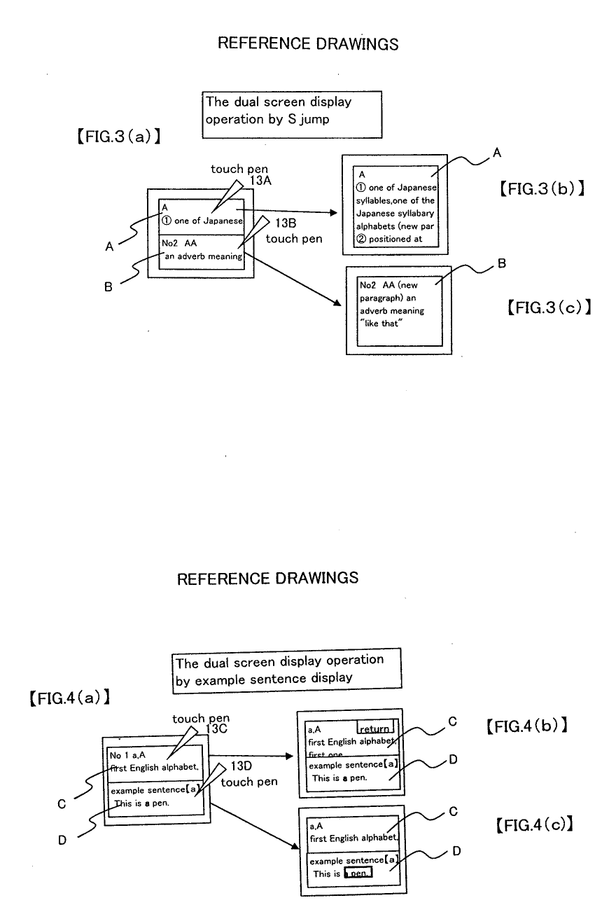

The function acquiring unit 30 is a part that acquires a function corresponding to a letter type as letter type function corresponding information from a functional highlighted letter type correspondence table 40 shown in FIGS. 3(a) to 3(c).

The data unit 3 includes the content direction word searching information database unit 31, the content example sentence searching information database unit 32, the content idiom searching information database unit 33, the content direction word list display information database unit 34, the content example sentence list display information database unit 35, the content idiom list display information database unit 36, the content direction word description portion display information database unit 37, the content example sentence portion display information database unit 38, the content idiom portion display information database unit 39, and the functional highlighted letter type correspondence table 40.

The content direction word searching information database unit 31 includes a direction word searching information storing unit 31a for a content 1, a direction word searching information storing unit 31b for a content 2, a direction word searching information storing unit 31c for a content 3, and the like. The content direction word searching information database unit 31 stores searching information a searching keyword of which is composed of one English word. When the keyword is composed of one English word, the content direction word searching unit 22 searches for searching information in the content direction word searching information database unit 31 by using the keyword. In this case, the contents include language dictionaries such as a Japanese dictionary, a Chinese character dictionary, an English dictionary, a German dictionary, a French dictionary, a Chinese dictionary, and the like, technical term dictionaries such as an electric term dictionary, a machine technical term dictionary, a chemistry dictionary, and the like, and an encyclopedia, a contemporary dictionary, a legal term dictionary, and other dictionaries. These contents are exemplification, all the contents need not be included, and arbitrary contents can be selected therefrom. The same applies to the following description. The content direction word searching unit 22 searches for a direction word in the content direction word searching information database unit 31.

The content example sentence searching information database unit 32 includes an example sentence searching information storing unit 32a for the content 1, an example sentence searching information storing unit 32b for the content 2, an example sentence searching information storing unit 32c for the content 3, and the like. The content example sentence searching information database unit 32 stores example sentence searching information a searching keyword of which is composed of a plurality of English words. When the keyword is composed of the plurality of English words, the content example sentence searching unit 23 searches for an example sentence in the content example sentence searching information database unit 32 by using the keyword.

The content idiom searching information database unit 33 includes an idiom searching information storing unit 33a for the content 1, an idiom searching information storing unit 33b for the content 2, an idiom searching information storing unit 33c for the content 3, and the like. The content idiom searching information database unit 33 stores idiom searching information a searching keyword of which is composed of a plurality of English words. When the keyword is composed of the plurality of English words, the content idiom searching unit 24 searches for idiom searching information in the content idiom searching information database unit 33 by using the keyword.

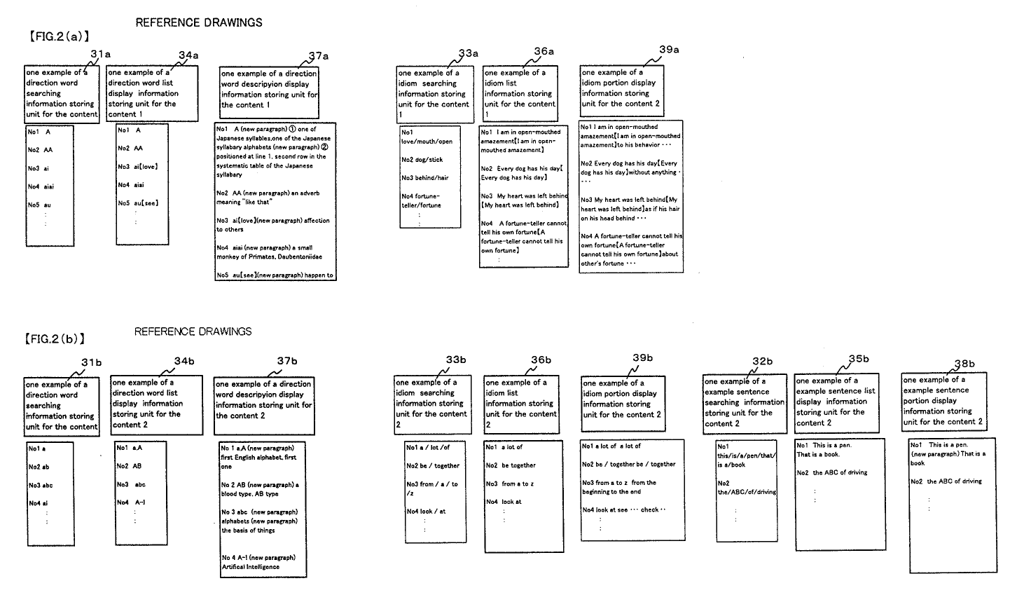

Idiom searching will be explained in the following. For example, when idiom searching is performed by two keywords including a first keyword of “a” and a second keyword of “lot”, the idiom searching information storing unit 33b for the content 2 shown in FIG. 2(a) is searched for because the searching keyword is composed of the plurality of English words. Searching is performed by the first keyword to determine whether or not a list having the first keyword “a” is included in the idiom searching information storing unit 33b. As a result, in the idiom searching information storing unit 33b, pieces of idiom information No. 1 and No. 3 each including “a” are searched for. The searched pieces of idiom information No. 1 and No. 3 are searched to determine whether or not the pieces of idiom information No. 1 and No. 3 include the second keyword “lot”. As a result, the idiom information No. 1 is searched for.

In the example described above, the searching by using two keywords is explained. When there is a third keyword, the above searching is repeated until all the keywords are covered. Information in a content idiom portion display information storing unit 39b corresponding to the idiom information in the lastly remaining content idiom searching information storing unit 33b is an idiom search result. In this example, the idiom information No. 1 “a lot of [symbol] [symbol] ” is displayed on the display unit 11.

The content direction word list display information database unit 34 includes a direction word list display information storing unit 34a for the content 1, a direction word list display information storing unit 34b for the content 2, a direction word list display information storing unit 34c for the content 3, and the like. The content direction word list display information database unit 34 stores pieces of direction word list display information on the contents 1 to n. When the direction word list display information on the content k is searched for by using a keyword, the searched direction word list display information is output.

The content example sentence list display information database unit 35 includes an example sentence list display information storing unit 35a for the content 1, an example sentence list display information storing unit 35b for the content 2, an example sentence list display information storing unit 35c for the content 3, and the like. The content example sentence list display information database unit 35 stores pieces of example sentence list display information on the contents 1 to n. When the example sentence list display information on the content k is searched for by using a keyword, the searched example sentence list display information is output.

The content idiom list display information database unit 36 includes an idiom list display information storing unit 36a for the content 1, an idiom list display information storing unit 36b for the content 2, an idiom list display information storing unit 36c for the content 3, and the like. The content idiom list display information database unit 36 stores pieces of idiom list display information on the contents 1 to n. When the idiom list display information on the content k is searched for by using a keyword, the searched idiom list display information is output.

The content direction word description portion display information database unit 37 includes a direction word description portion display information storing unit 37a for the content 1, a direction word description portion display information storing unit 37b for the content 2, a direction word description portion display information storing unit 37c for the content 3, and the like. The content direction word description portion display information database unit 37 stores pieces of direction word description portion display information on the contents 1 to n. The content direction word description portion display information database unit 37 may store, in addition to the pieces of direction word description portion display information on the contents 1 to n, relevant data or link information related to the content direction word description portion display information database unit 37. The content direction word description portion display information database unit 37 stores the pieces of direction word description portion display information on the contents 1 to n. When the description portion display information on the content k is searched for by using a keyword, the searched direction word description portion display information is output.

The content example sentence portion display information database unit 38 includes an example sentence portion display information storing unit 38a for the content 1, an example sentence portion display information storing unit 38b for the content 2, an example sentence portion display information storing unit 38c for the content 3, and the like. The content example sentence portion display information database unit 38 stores pieces of example sentence information on the contents 1 to n. The example sentence portion display information storing unit for a content that does not include an example sentence may not be provided. An example sentence is shown as relevant data corresponding to the description portion display information, and relevant data may be stored. The content example sentence portion display information database unit 38 stores example sentence portion display information on the contents 1 to n. When the example sentence portion display information on the content k is searched for by using a keyword, the searched example sentence portion display information is output.

The content idiom portion display information database unit 39 includes an idiom portion display information storing unit 39a for the content 1, an idiom portion display information storing unit 39b for the content 2, an idiom portion display information storing unit 39c for the content 3, and the like. The content idiom portion display information database unit 39 stores pieces of idiom information on the contents 1 to n. The idiom portion display information storing unit for a content that does not include idiom information may not be provided. The content idiom portion display information database unit 39 stores pieces of idiom portion display information on the contents 1 to n. When the idiom portion display information on the content k is searched for by using a keyword, the searched idiom portion display information is output.

The control unit 4 reads a control program, a document creating program, and a graphic/table creating program for the electronic dictionary included in the program unit 2, sequentially activates the respective units in accordance with the programs, and realizes a display control method according to the present invention. The temporary storing unit 5 is a part that temporarily stores various data.

FIGS. 2(a) and 2(b) are diagrams each exemplarily showing the content direction word searching information database unit 31, the content direction word list display information base unit 34, the content direction word description portion display information database unit 37, the content idiom searching information database unit 33, the content idiom list display information database unit 36, the content idiom portion display information database unit 39, the content example sentence searching information database unit 32, the content example sentence list display information database unit 35, and the content example sentence portion display information database unit 38.

In FIGS. 2(a) and 2(b), the content direction word searching information database unit 31, the content direction word list display information base unit 34, and the content direction word description portion display information database unit 37 configure one set of databases for direction word searching. The content idiom searching information database unit 33, the content idiom list display information database unit 36, and the content idiom portion display information database unit 39 configure one set of databases for idiom searching. Furthermore, the content example sentence searching information database 32, the content example sentence list display information database 35, and the content example sentence portion display information database unit 38 configure one set of databases for example sentence searching.

FIG. 2(a) shows only parts in one example of the direction word searching information storing unit 31a for the content 1, the direction word list display information storing unit 34a for the content 1, and the direction word description portion display information storing unit 37a for the content 1 in a case where the content 1 is a Japanese dictionary. Also shown are only parts in one example of the idiom searching information storing unit 33a for the content 1, the idiom list display information storing unit 36a for the content 1, and the idiom portion display information storing unit 39a for the content 1.

Since the content 1 does not include example sentence information, an example sentence searching information storing unit, an example sentence list display information storing unit, and an example sentence portion display information storing unit are not provided.

FIG. 2(b) shows only parts in one example of the direction word searching information storing unit 31b for the content 2, the direction word list display information storing unit 34b for the content 2, and the direction word description portion display information storing unit 37b for the content 2 in a case where the content 1 is an English dictionary. Also shown are only parts in one example of the idiom searching information storing unit 33b for the content 2, the idiom list display information storing unit 36b for the content 2, and the idiom portion display information storing unit 39b for the content 2. Furthermore, shown are only parts in one example of the example sentence searching information storing unit 32b for the content 2, the example sentence list display information storing unit 35b for the content 2, and the example sentence portion display information storing unit 38b for the content 2.

Although a direction word searching information storing unit 31k for the content k, a direction word list display information storing unit 34k for the content k, a direction word description portion display information storing unit 37k for the content k, an idiom searching information storing unit 33k for the content k, an idiom list display information storing unit 36k for the content k, an idiom portion display information storing unit 39k for the content k, an example sentence searching information storing unit 32k for the content k, an example sentence list display information storing unit 35k for the content k, and an example sentence portion display information storing unit 38k for the content k are included for each of the n contents, these units are not shown in the drawings.

According to the present invention, as shown in FIG. 2(a), the direction word searching information storing unit 31k for the content k, the direction word list display information storing unit 34k for the content k, the direction word description portion display information storing unit 37k for the content k, the idiom searching information storing unit 33k for the content k, the idiom list display information storing unit 36k for the content k, the idiom portion display information storing unit 39k for the content k, the example sentence searching information storing unit 32k for the content k, the example sentence list display information storing unit 35k for the content k, and the example sentence portion display information storing unit 38k for the content k are referred to as related contents. The contents stored in FIG. 2(a), FIG. 2(b), and the like are referred to as unrelated contents.

Direction word searching information, direction word list display information, direction word description portion display information, idiom searching information, idiom list display information, idiom portion display information, example sentence searching information, example sentence list display information, and example sentence portion display information each having the same content number are related contents, and direction word searching information, direction word list display information, direction word description portion display information, idiom searching information, idiom list display information, idiom portion display information, example sentence searching information, example sentence list display information, and example sentence portion display information having different content numbers are unrelated contents.

In the direction word searching information storing units 31a, 31b, and the like for the content k shown in FIGS. 2(a) and 2(b), when a keyword is composed of one word, a direction word is searched for by using the keyword. When one search result or a plurality of search results are obtained, the corresponding direction words are output from the direction word list display information storing units 34a, 34b, and the like and displayed on the display unit 11. When one result is obtained, description information corresponding to the direction word is read from the direction word description portion display information storing units 37a, 37b, and the like and displayed on the display unit 11. When a plurality of search results are obtained, a plurality of direction words are displayed on the display unit 11. When one of the plurality of direction words is selected, corresponding description information is read from the direction word description portion display information storing units 37a, 37b, and the like and displayed on the display unit 11.

In idiom searching, when a keyword is composed of a plurality of words, direction words in the idiom searching information storing units 33a, 33b, and the like for the content k are searched for by using the keyword. When one search result or a plurality of search results are obtained, the corresponding idioms are output from the idiom list display information storing units 36a, 36b, and the like and displayed on the display unit 11. When one result is obtained, idiom information corresponding to the idiom is read from the idiom portion display information storing units 39a, 39b, and the like and displayed on the display unit 11. When a plurality of search results are obtained, a plurality of idioms are displayed on the display unit 11. When one of the plurality of idioms is selected, corresponding idiom information is read from the idiom portion display information storing units 39a, 39b, and the like and displayed on the display unit 11.

Furthermore, in example sentence searching, when a keyword is composed of a plurality of words, example sentences in the example sentence searching information storing units 32a, 32b, and the like for the content k are searched for by using the keyword. When one search result or a plurality of search results are obtained, the corresponding example sentences are output from the example sentence list display information storing units 35a, 35b, and the like and displayed on the display unit 11. When one result is obtained, example sentence information corresponding to the example sentence is read from the example sentence portion display information storing units 38a, 38b, and the like and displayed on the display unit 11. When a plurality of search results are obtained, a plurality of example sentences are displayed on the display unit 11. When one of the plurality of example sentences is selected, example sentence information is read from the example sentence portion display information storing units 38a, 39b, and the like and displayed on the display unit 11.

FIGS. 3(a) to 3(c) are explanatory diagrams each showing a display state controlled by the display control apparatus according to the present invention.

FIG. 3(a) shows a display state in which contents A and B unrelated to each other are divisionally displayed on two upper and lower screens of the display unit 11. A direction word of a Japanese word “ [symbol] ” and a meaning (description) of the word are displayed in an upper section. A lower section displays a direction word of a Japanese word “ [symbol] ” and a meaning (description) thereof. In this case, the contents A and B displayed in the upper and lower sections, as described in FIGS. 2(a) and 2(b), are unrelated contents. The dual screen display is performed when an S jump function is used.

In this case, when a user touches the upper section of the display unit 11 with a touch pen 13A by using the touch panel input unit 13, as shown in FIG. 3(b), the content A in the upper section is displayed on a single screen of the display unit 11. The upper section of the display unit 11 may be designated by using a mouse in place of the touch panel. Although only an operation with the touch pen will be explained in the following description, an operation can be performed by using a mouse in place of the touch pen.

When the content A is displayed on the single screen, as a display area increases, a part of the content A that is not divisionally displayed in FIG. 3(a) appears. As a matter of course, when a user touches the lower section of the display unit 11 with a touch pen 13B, as shown in FIG. 3(c), the content B in the lower section is displayed on a single screen of the display unit 11. When the display area increases, a part of the content B that is not divisionally displayed in FIG. 3(a) appears.

In this manner, as shown in FIGS. 3(a) to 3(c), when the contents A and B unrelated to each other are displayed on the divided screens, if any one of the screens is touched, the operation is interpreted as screen transition to change the screen display as shown in FIG. 3(b) or FIG. 3(c).

In the present invention, the divided screens mean that the apparatus has at least two screens, and the screens may simultaneously display other icons and marks. Single screen display (or a whole-area screen) may occupy an entire screen, or other icons and marks may be simultaneously displayed in a part of the single screen display (the whole-area screen). The same applies to the following description.

FIGS. 4(a) to 4(c) are explanatory diagrams each showing another display state controlled by the display control apparatus according to the present invention.

FIG. 4(a) shows a display state in which contents C and D related to each other are divisionally displayed on two upper and lower screens of the display unit 11. A direction word of, for example, an English word “a, A” and a meaning (description) thereof are displayed on the upper screen. The lower screen, displays English example sentences corresponding to the word. In place of the example sentences, relevant information may be displayed, or such an example sentence and the relevant information may be displayed.

In this display state, when a user touches the upper screen with a touch pen 13C, the operation is determined as meaningless and voided because the meaning (description) serving as detailed information on the direction word is displayed on the upper screen, and the display is not changed as shown in FIG. 4(b). In this case, a “return” button to return to a previous screen is displayed at a corner on the upper screen. However, when the lower screen is touched with a touch pen 13D, example sentences serving as information related to the direction word on the upper screen are displayed on the lower screen. Since the example sentence is not a word, as shown in FIG. 4(c), the touching operation is determined as a highlighting operation, and an area operated with the touch pen 13D is selected. In this case, the display screen in FIG. 4(a) is not changed. FIG. 4(c) shows that a state in which “a pen” is highlighted. As the highlighting operation performed with the touch pen 13D, only a start point and an end point may be touched, or an operation of tracing from the start point to the end point with a touch panel may be performed.

In this case, when the lower screen is touched, the operation is determined as a highlighting operation. Similarly, when the upper screen is touched, the operation may be determined as a highlighting operation. More specifically, when contents related to each other are displayed on the upper screen and the lower screen, a highlighting operation is determined to be performed by touching any one of the upper screen and the lower screen, and a highlighting process is performed.

When the lower screen is touched and a touched position is not a letter display portion, a touching operation is voided.

By a next action designating operation performed by a user, the highlighted portion as described above is colored (marker function), searching is performed by using the highlighted portion as a keyword (S jump function), or a word or a sentence is pronounced (word pronunciation or a text reading function). In this case, the “marker function” displays a background of all the selected letter and symbol portions in a color different from a letter display color. The “S jump function” uses one word configured by only selected alphabetic characters or selected a Japanese letter string (for example, a letter string including Chinese characters, hiragana characters, and/or katakana characters) as a direction word to search in a loaded Japanese dictionary and the like for information corresponding to the direction word. The selected letter string is not limited to Japanese letters, and a displayed letter string in a different language can also be selected. In this case, information on a content depending on the language can be searched for. A “word pronunciation reproducing function” outputs as voice reading of one English word as a letter string configured only by selected alphabets (alphabetic characters). A “text pronunciation reproducing function” outputs a text configured by a plurality of selected English words as synthetic voice.

When a dictionary in a language (Chinese or the like) except for English is loaded on an electronic dictionary or the like, it is assumed that an executable function is determined in advance for not only English words or English texts but also words or texts in the different language and that a specific function is executed in accordance with a selected letter string.

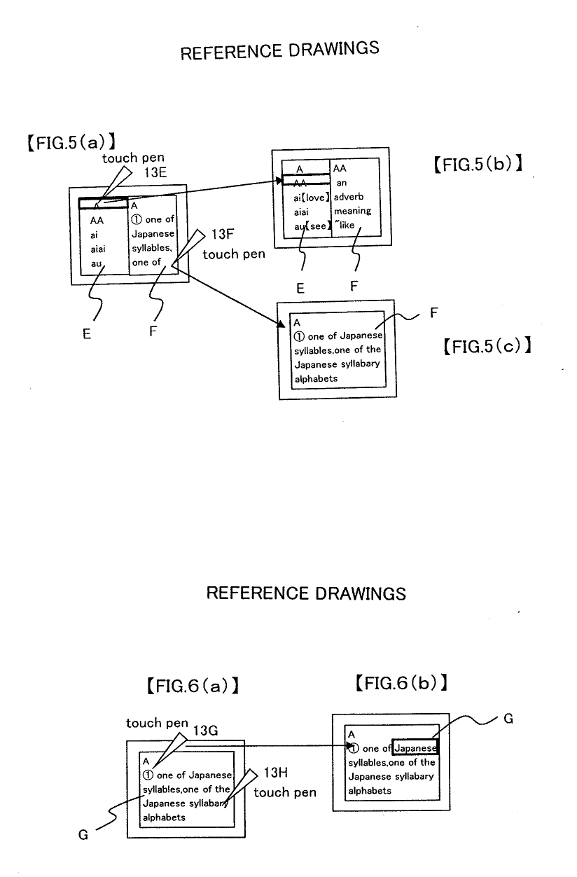

FIGS. 5(a) to 5(c) are explanatory diagrams each showing still another display state controlled by the display control apparatus according to the present invention.

FIG. 5(a) shows a state in which contents E and F related to each other are divisionally displayed on two left and right screens of the display unit 11. The left screen shows a list of direction words such as Japanese words “ [symbol] ”, “ [symbol] , [symbol] ”, “ [symbol] ”, and “ [symbol] ”, and the right screen displays a meaning (description) of the Japanese word “ [symbol] ” assuming that the listed direction word “ [symbol] ” is determined to be selected. Since the right screen has a small display area, a part of the description of “ [symbol] ” is displayed on the right screen.

When a user selects a direction word displayed as the list on the left screen of the display unit 11 and touches the word “ [symbol] ” with a touch pen 13E, as shown in FIG. 5(b), a meaning (description) corresponding to the touched direction word is displayed on the right screen.

In the display state shown in FIG. 5(a), when the user touches the right screen with a touch pen 13F, as shown in FIG. 5(c), the right screen is displayed on a single screen of the display unit 11. When a display area increased, a content F that is not in the divisional display in FIG. 5(a) appears.

When the right screen is touched and the touched position is not a letter display portion, the touching operation is voided.

In this manner, when pieces of information related to each other are displayed on the divided screens and one of the screens is touched with a touch pen, the operation is interpreted as screen transition to change a screen display as shown in FIG. 5(b) or FIG. 5(c).

FIGS. 6(a) and 6(b) are explanatory diagrams each showing another display state controlled by the display control apparatus according to the present invention.

FIG. 6(a) shows a display state in which a content G is displayed on a single screen of the display unit 11. More specifically, in the display state, a direction word of a Japanese word “ [symbol] ” and a meaning (description) thereof are displayed. The state in which the content G is displayed on the single screen is obtained by screen transition shown in, for example, FIGS. 3(b) and 3(c) and FIG. 5(c).

The display state is a state in which a user reaches a target screen, and a user's screen touch operation does not require screen transition but is a selecting process on the display contents. The display state in FIGS. 6(a) and 6(b) is single screen display and is different from a dual screen display state as shown in FIG. 3(a) to FIG. 5(a), so that a touching operation with a touch pen is performed differently from each other at a letter display portion and a portion where a letter is not displayed in the content as follows.

As shown in FIG. 6(a), in a state in which the content G is displayed on the single screen and a touching operation with a touch pen 13G is performed onto a letter display portion, the operation is processed as a highlighting operation. FIG. 6(b) shows the selecting process. In FIG. 6(b), for example, it is understood that “ [symbol] ” is highlighted, and an area thereof is displayed. The highlighted area is indicated with a square frame in FIG. 6(b). As the highlighting operation performed with the touch pen 13G, only a start point and an end point may be operated, or an operation of tracing from the start point to the end point with the touch pen 13G may be performed. Whether operation position coordinates of the touch pen 13G are in a letter display portion or a non-display portion of the content G is determined by whether data stored in the display buffer unit 26 is a letter string portion or a space portion. For example, the space portion is a remaining portion after a punctuation mark (“∘” added to the end of a text) of a text.

By the following action designating operation by a user, coloring (marker function), searching by using a highlighted portion as a keyword (S jump function), or pronouncing (word pronunciation or text reading function) is performed to the selected portion.

However, when a touching operation with a touch pen 13H is not performed on a letter display portion of a content, such an operation is voided.

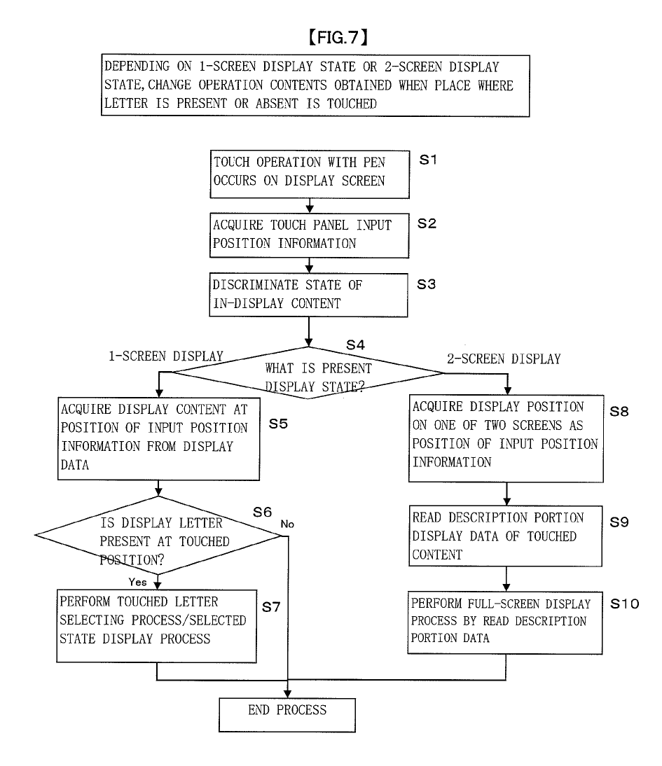

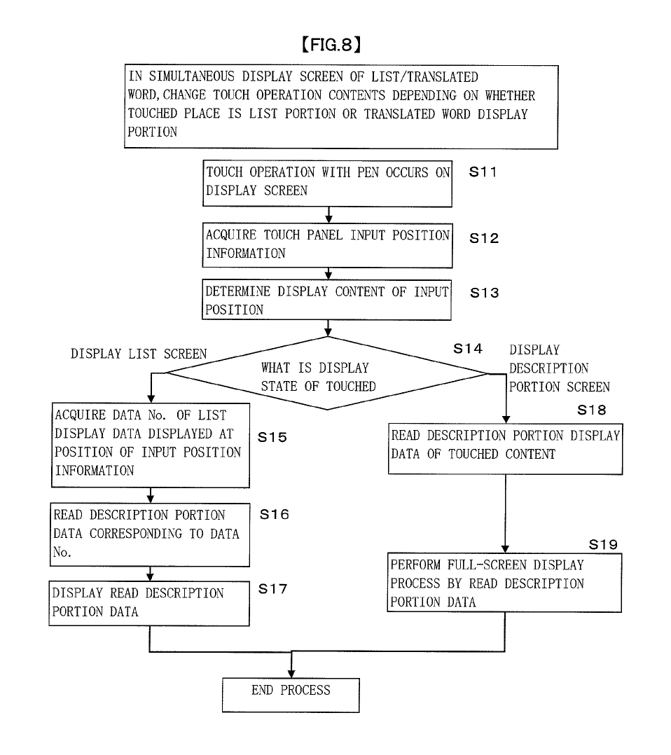

By using the configurations in the block diagrams shown in FIGS. 1, 2(a), and 2(b), the actions shown in FIGS. 3(a) to 6(b) are realized by being processed as in the flow charts shown in FIGS. 7 to 9.

The flow chart in FIG. 7 shows processes performed when a user touches an information display portion and when the user touches a portion except for the information display portion depending on a single screen display state or a dual screen display state. More specifically, the case in FIGS. 3(a) to 3(c) as well as the case in FIGS. 6(a) and 6(b) will be described, respectively.

First, in step S1, a content is displayed on the display screen of the display unit 11, and a user touches the screen by using a touch pen. In this manner, a touching operation with the touch pen occurs on the display screen. Next in step S2, an input to the touch panel is accepted by the touch panel input unit 13, and input position information is acquired by a touch panel input accepting unit 23. More specifically, a coordinate position on the display screen is detected. In step S3, a state of the in-display content is discriminated by the in-display content state discriminating unit 28. This is performed by detecting display data in the display buffer unit 26.

On the basis of the discrimination, in step S4, it is determined whether the present display is in a single screen display state or a dual screen display state. In the case of single screen display, the flow shifts to step S5 to determine, in steps S5 to S7, whether or not the coordinate position designated with the touch pen is a content display portion. More specifically, in step S5, a display content including the position designated with the touch pen is acquired from display data in the display buffer unit 26. In step S6, it is determined whether or not the coordinate position touched with the touch pen is in a letter display portion of the content. When the touched coordinate position is in the letter display portion of the content (Yes), in step S7, the control unit 4 performs a selecting process of a touched letter to perform a display process to indicate a selecting state. More specifically, as shown in FIG. 6(b), an area of a portion including the touched portion and processed by the touching operation is displayed with a square frame. On the other hand, when the touched coordinate position is not in a letter display portion of the content (No), this flow ends. More specifically, an operation of designating a touching operation is voided.

In step S4 described above, in the case of dual screen display, the flow shifts to step S8, and a full-screen display process is performed in steps S8 to S10. More specifically, in step S8, which one of the two screens includes the position designated with the touch panel is acquired from the content display buffer unit 26. In step S9, a display content including the position designated with the touch panel is read from display data in the content description portion display information database 33 by the content display processing unit 25. In step S10, the read display data is processed such that a full-screen display of the display data is performed by the display processing unit 21. More specifically, as shown in FIGS. 3(a) to 3(c), the touched screen is displayed as a full screen. In this example, the display data in the content description portion display information database 33 is read in step S9. Alternatively, when in-display data is stored, the display data may be acquired from the storing unit. Still alternatively, the display data in the display buffer unit 26 may be enlarged and displayed.

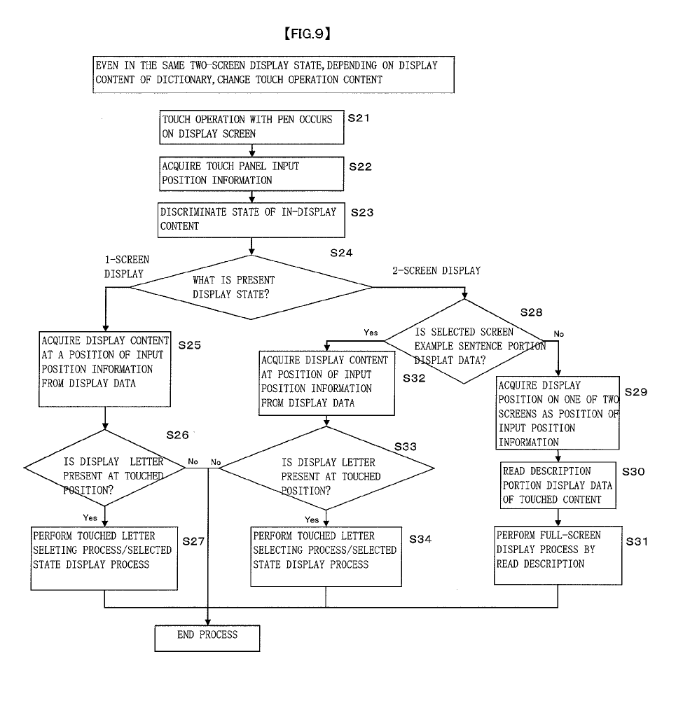

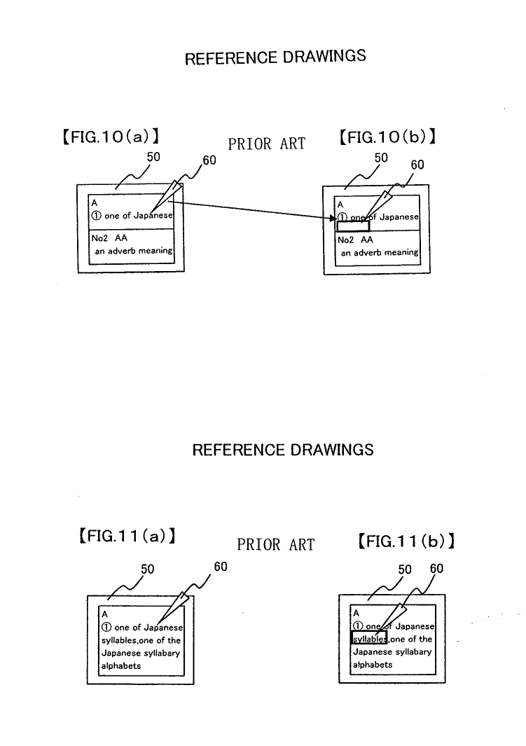

FIG. 8 is a flow chart obtained in a case in which, when a list of direction words and translated words thereof are simultaneously displayed in dual screen display, actions are changed depending on whether a portion touched with a touch pen is on a list display screen or on a description portion display screen. More specifically, the actions in FIGS. 5(a) to 5(c) will be described.

First two steps S11 and S12 are the same as steps S1 and S2 in FIG. 7. In the next step S13, a display content of an input position with a touch pen is determined. In step S14, it is determined whether a display state at a touched position is a list display screen state or a description portion display screen state thereof. This discrimination is performed by causing an in-display content state discriminating unit 27 to detect the display data in the display buffer unit 26.

If the list display screen is displayed, the flow shifts to steps S15 to S17. In step S15, data No. of a list display data displayed at an input position with the touch panel is acquired. In the next step S16, description portion data corresponding to the data No. acquired in step S15 is read from the content description portion display information database unit 33. In step S17, the read description portion data is displayed. Thereafter, the flow ends.

In step S14 described above, when the display is in a state in which the touched position is on a description portion screen, the flow shifts to steps S18 and S19. In step S18, the description portion display data of the touched content is read from the content description portion display information database unit 33, and, in step S19, the description portion data is displayed. Thereafter, this flow ends.

FIG. 9 is a flow chart obtained when the touch action content is changed depending on the display content displayed on the display screen. More specifically, the actions in FIGS. 4(a) to 4(c) will be described.

In FIG. 9, steps S21 to S31 correspond to steps S1 to S10 shown in FIG. 7, and the same processes are performed.

In the flow chart in FIG. 9, in step S28 subsequent to step S24, it is determined whether or not a screen selected by the in-display content state discriminating unit 28 displays example sentence display data. When the screen does not display the example sentence display data (No), the processes in steps S29 to S31 are performed.

On the other hand, when the screen displays the example sentence display data (Yes), the flow shifts to steps S32 to S34. In step S32, a display content at a position of input position information is acquired from display data. In the next step S33, it is determined whether or not a display letter is present at a touched position. When the touched position is on the display letter (Yes), in step S34, a selecting process of the touched letter and a display process of the selecting state are performed, and this flow ends.

In step S33 described above, when a display letter is not present at the touched position (No), this flow ends.

1. A display control apparatus comprising:
a display unit that can display contents on one screen or a plurality of screens;
a designating unit that designates an arbitrary position on the screen of the display unit;
a determining unit that, when the contents are displayed on the plurality of screens of the display unit, determines whether or not the contents are related to each other; and
a control unit that switches the screen including the position designated by the designating unit based on a determination result obtained by the determining unit.

2. The display control apparatus according to claim 1, wherein, when the determining unit determines that the contents displayed on the plurality of screens are related to each other, detailed information including one or a plurality of direction words is displayed on one of the screens, and relevant information corresponding to one of the direction words is displayed on another one of the screens.

3. The display control apparatus according to claim 2, wherein, when the determining unit determines that the contents displayed on the plurality of screens are related to each other as well as when detailed information on a word included in the content is displayed on one of the screens and relevant information on the word is displayed on another one of the screens, the control unit, when the designating unit designates one of the screens, processes the designated area as being highlighted.

4. The display control apparatus according to claim 3, wherein, when the designating unit designates another one of the screens, the control unit voids the designating operation.

5. The display control apparatus according to claim 3, wherein
the detailed information includes a translated word (word meaning), an explanatory sentence, or a phonetic symbol corresponding to the direction word, and
the relevant information includes an example sentence, a description, an idiom, or a complex word serving as information related to the direction word except for the detailed information.

6. The display control apparatus according to claim 1, wherein, when the determining unit determines that the contents displayed on the plurality of screens are related to each other as well as when a list of a plurality of words included in the content is displayed on one of the screens and detailed information on one of the plurality of words is displayed on another one of the screens, the control unit, when the designating unit designates the screen on which the list of the plurality of words is displayed, performs a process of selecting a word at a designated position.

7. The display control apparatus according to claim 6, wherein, when the designating unit designates the screen on which the detailed information on the word is displayed, the control unit performs a process of displaying the designated screen as a full screen.

8. The display control apparatus according to claim 1, wherein, when the determining unit determines that the contents displayed on the plurality of screens are not related to each other, a direction word is displayed on one of the screens and a direction word different from the direction word is displayed on another one of the screens.

9. The display control apparatus according to claim 1, wherein, when the determining unit determines that the contents displayed on the plurality of screens are not related to each other, the control unit, when the designating unit designates one of the screens, performs a process of displaying the screen designated by the designating unit as a full screen.

10. The display control apparatus according to claim 1, wherein, when the content is displayed on the display screen, the control unit, when the designating unit designates a display portion of the content, highlights the designated area and, when the designating unit designates an area that is not the display portion of the content, the voids the designated operation.

11. The display control apparatus according to any one of claims 1, 3, 6, 7, 8, and 10, wherein the designating unit is a touch sensor arranged on the display screen.

12. The display control apparatus according to claim 1, wherein the display control apparatus controls a display control unit of an electronic dictionary.

13. A display control method comprising:
a display step of displaying contents on one screen or a plurality of screens;
a designating step of designating an arbitrary position on the plurality of screens;
a determining step of determining whether or not the contents displayed on the plurality of screens are related to each other; and
a control step of switching a screen including the position designated by the designating step based on a determination result obtained by the determining step.
